(19) United States
(12) Patent Application Publication
(10) Pub. No.: US 2007/0034057 A1
(43) Pub. Date: Feb. 15, 2007

(54) Systems and methods for stripping insulation from wires

(76) Inventor: Mehrzad Khoshneviszadeh, Woodstock, GA (US)

Correspondence Address: Mehrzad Khoshneviszadeh, 626 Devon Brooke Drive, Woodstock, GA, 30188, US

(21) Appl. No.: 11/201,492

(22) Filed: Aug. 11, 2005

(51) Int. Cl. H02G 1/12

(52) U.S. Cl. 81/9.51; 83/861; 83/924

(57) ABSTRACT

An embodiment of a wire stripping system includes: a heating chamber having at least one opening; an electric heating device configured to heat said heating chamber; and wherein heat generated by said heating device is configured to burn the insulation on a portion of a wire.

### BACKGROUND

Some existing wire stripping systems remove insulation from a wire (e.g., magnet wire) using heat to burn off the exterior insulation, using chemicals, and using mechanical means of stripping. However, such wire stripping systems may be complicated, costly and/or may damage thin magnet wires while removing the exterior insulation from the wire. Therefore there exists a need for systems and methods that address these and/or problems associated with existing wire stripping systems.

### SUMMARY

Systems and methods for stripping insulation off insulated wires without damaging said insulated wires are provided. An embodiment of a wire stripping system includes: a heating chamber having at least one opening; an electric heating device configured to heat said heating chamber; and wherein heat generated by said heating device is configured to burn the insulation on a portion of a wire.

A method for using a wire stripping system includes: inserting a portion of an insulated wire into a heating chamber of a wire stripping system; removing said portion from said heating chamber responsive to feedback from said wire stripping system indicating that insulation has been burned on said portion; and wherein said insulation is removed responsive to heat within said heating chamber.

A method for operating a wire stripping system, said method comprising: receiving a portion of an insulated wire into a heating chamber of a wire stripping system; heating said heating chamber to a predetermined temperature; and providing a signal to a user instructing said user to remove said portion from said heating chamber after insulation has been burned on said portion.

Other systems, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a block diagram depicting an example of a wire stripping system according to an embodiment of the invention, among others.

FIG. 2A-2B are schematic diagrams depicting an example of a heating system according to an embodiment of the invention, among others.

FIG. 3A-3B are schematic diagrams depicting an example of a wire stripping system according to an embodiment of the invention, among others.

FIG. 3C-3D are schematic diagrams depicting the internal components of a wire stripping system according to an embodiment of the invention, among others.

FIG. 4 is a flowchart depicting a method for operating a wire stripping system according to an embodiment of the invention, among others.

FIG. 5 is a flowchart depicting a method for determining a required temperature and a time according to an embodiment of the invention, among others.

FIG. 6 is a flowchart depicting a method for operating a wire stripping system according to an embodiment of the invention, among others.

FIG. 7A-7B are graphs depicting temperature versus time in a heating chamber according to an embodiment of the invention, among others.

FIG. 8 is a graph depicting an example temperature versus time in a heating chamber according to an embodiment of the invention, among others.

### DETAILED DESCRIPTION OF THE PREFERRED EMBODIMENTS

As will be described in greater detail herein, an embodiment of the present invention comprises a wire stripping system to burn the insulation off of a wire (e.g., a magnet wire, also known as a winding wire) and strip off insulating material from thin wires by light polish via a heating device (e.g. nichrome wire heating element or any other suitable material). The wire stripping system may be configured to burn off insulation from wires of various diameters. The wire stripping system may be contained in a case which may be fixed or portable and may be powered by an external or an internal power supply. The case of the wire stripping device may include a feedback mechanism on the exterior (e.g., Audible sound, a light-emitting diode (LED), etc.).

One application of the wire stripping system is stripping insulation off extremely thin wires (e.g., 25-56 AWG, less than 0.03 inches in diameter). It is important to monitor and regulate the temperature in a heating chamber to remove the insulation off the thin wire so as to not damage the wire itself. The charred insulation may be removed, for example, using a fine (e.g., 600 Grid) polishing paper. Logic and timing circuits may limit the time the heating device is active to produce the desired temperature in the heating chamber. For successive uses, the wire stripping system may include a cooling device (e.g., fan using factory air or other inert gases) to bring the system back to an ambient temperature. Alternatively to increase the usage rate, the wire stripping system may comprise a logic and timing circuit which measures the temperature inside the heating chamber and heats the heating device responsive to the current temperature.

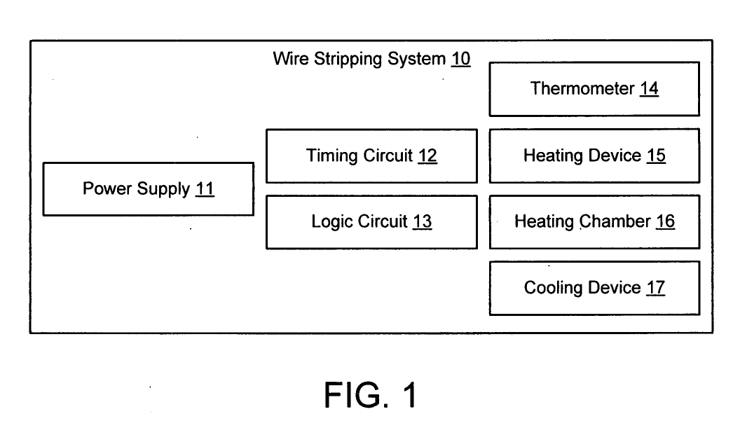

Referring now to the drawings, FIG. 1 is a block diagram depicting an example of a wire stripping system 10 according to an embodiment of the invention, among others. The wire stripping system 10 may comprise a power supply 11, a timing circuit 12, a logic circuit 13, a thermometer 14, a heating device 15, a heating chamber 16, and a cooling device 17. The power supply 11 provides electrical power to the wire stripping system 10. The power supply 11 may be external or internal to the wire stripping system 11 and may be, for example, an AC powered electrical device or a battery powered device. A portion of an insulated wire (e.g., a magnet wire) is placed into the heating chamber 16. The heating device 15 heats the heating chamber 16 to a predetermined temperature to burn the insulation off the wire and remove the insulation by light polish. The logic circuit 13 is configured to monitor and control the temperature in the interior of the heating chamber 16. The thermometer 14 may provide the interior temperature of the heating chamber 16. The timing circuit 12 is configured to determine the time a portion of the insulated wire is inside the heating chamber 16. The user may be alerted of the status by audible or visible notification (e.g., LED status and/or beep).

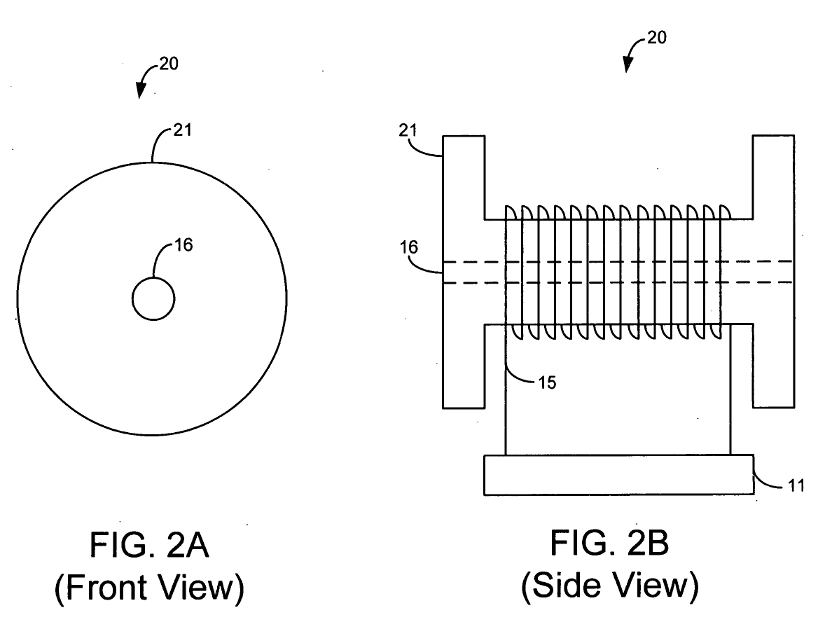

FIG. 2A-2B are schematic diagrams depicting an example of a heating system 20 according to an embodiment of the invention, among others. In this example, the heating system 20 comprises a bobbin 21, a heating chamber 16, a heating device 15, and a power supply 11. An insulated wire is inserted into the heating chamber 16. The heating chamber 16 is located in the interior of the bobbin 21 and contains an opening for an insulated wire to be inserted. The bobbin 21 comprises a suitable material for the transmission of heat to the heating chamber 16. The heating device 15 is connected to the power supply 11. In this example, the heating device 15 is located on or around the bobbin 21 to provide heat to the heating chamber 16. The heating device 15 may comprise, for example, a nichrome wire heating element and/or any other suitable material.

In one implementation, among others, a bobbin 21 may be a cylindrical shape comprising an interior cylinder and two exterior cylinders. The heating device 15 may be located, for example, around the interior cylinder. A diameter of the exterior cylinders may be at least 0.25 inches or any other defined diameter, depending on a defined implementation. A diameter of the interior cylinder may be less than the diameter of the exterior cylinder. A heating chamber 16 may be at least 0.03 inches in diameter, or any other defined diameter, depending on the defined implementation. The length from one exterior cylinder to the other exterior cylinder may be, for example, at least 0.22 inches. The length of the interior cylinder may be at least 0.16 inches.

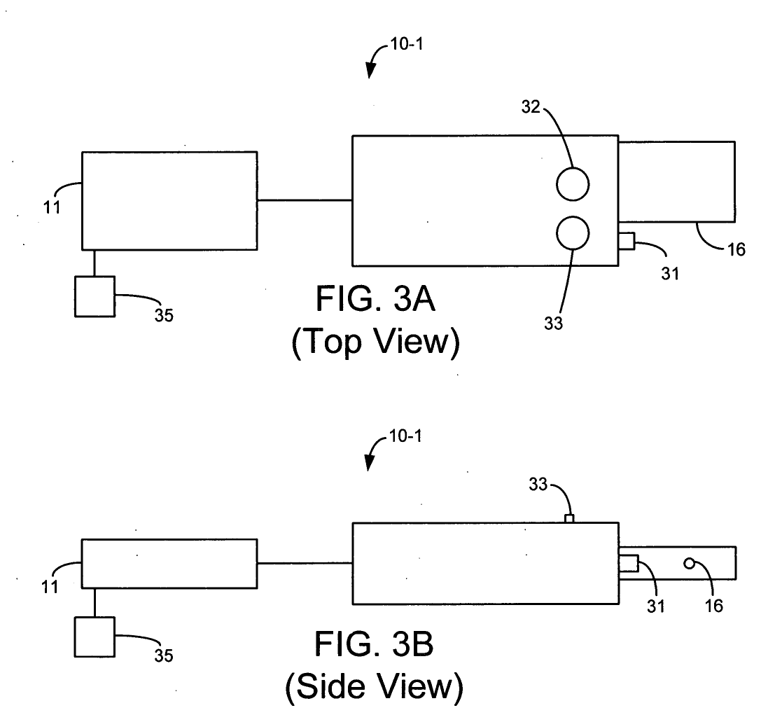

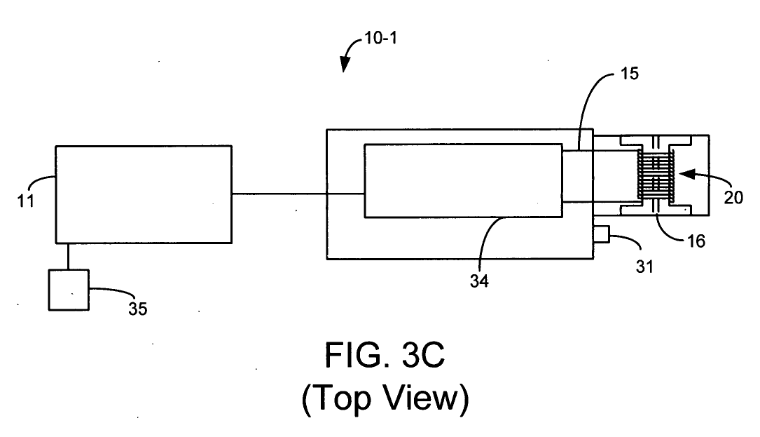

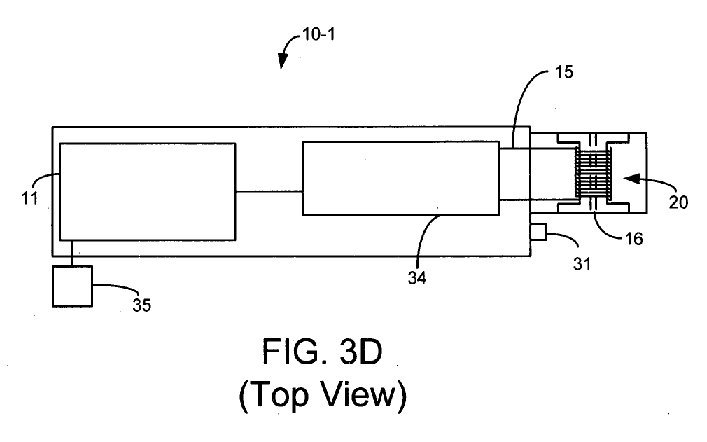

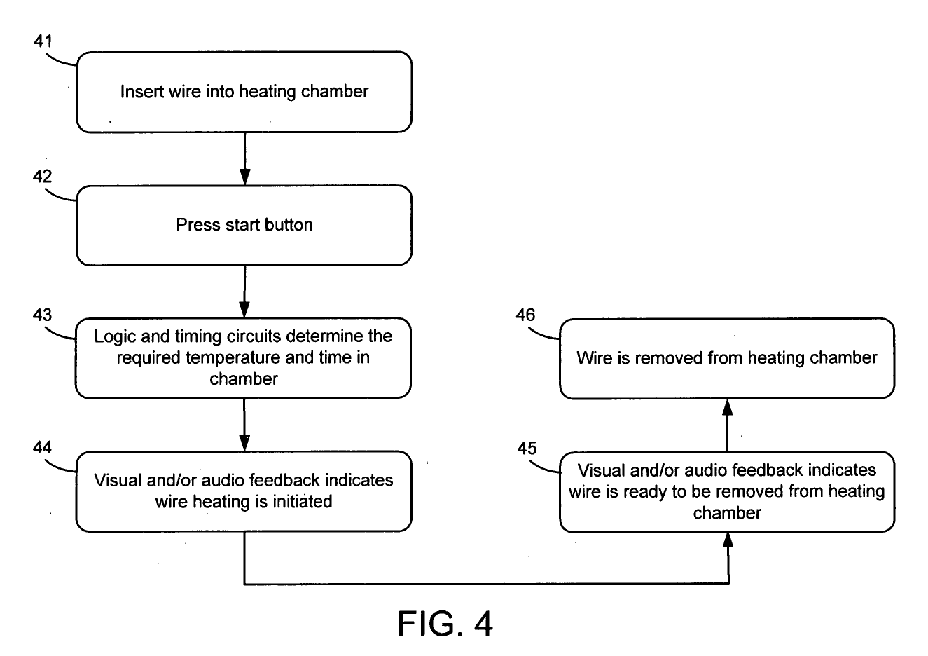

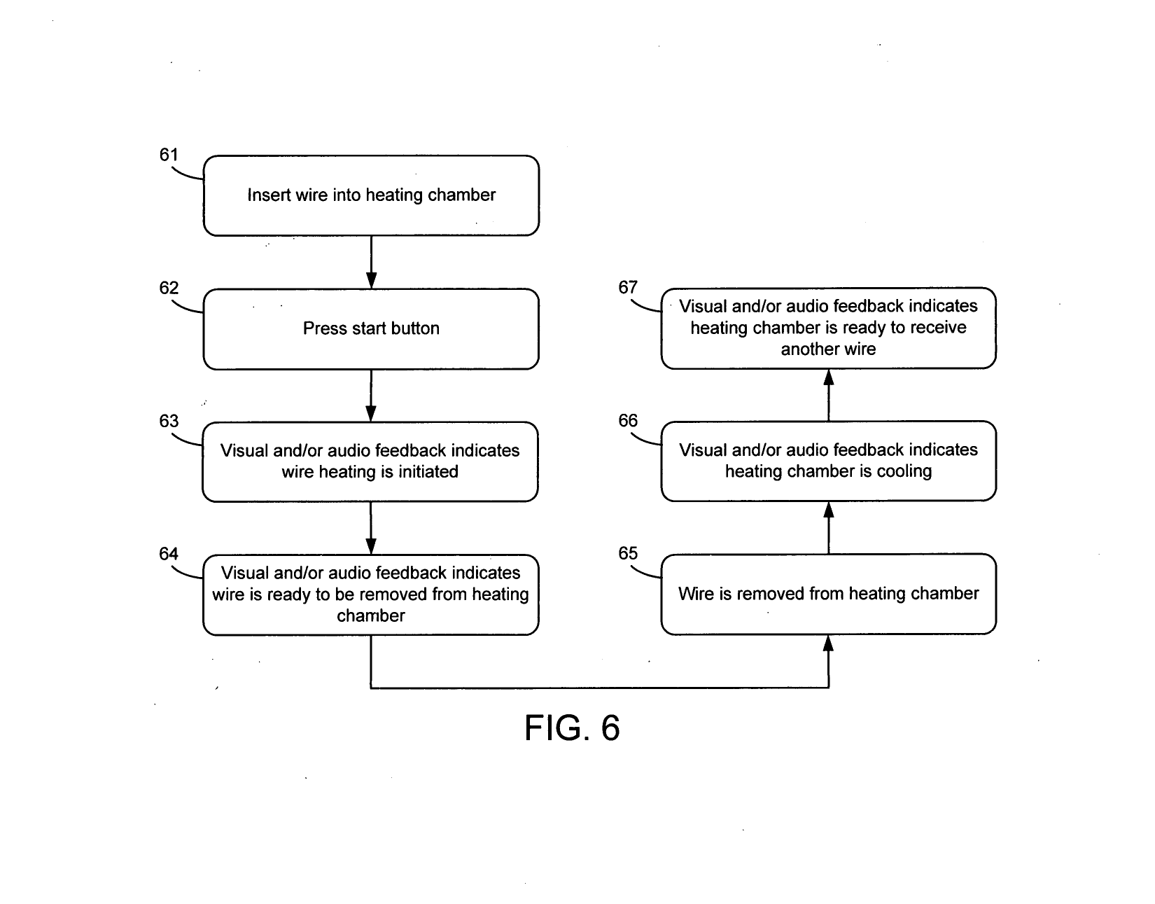

FIG. 3A-3B are schematic diagrams depicting an example of a wire stripping system 10-1 according to an embodiment of the invention, among others. The wire stripping system 10-1 comprises a power supply 11, a heating chamber 16, a start button 31, a wait LED 32, and a ready LED 33. In this example, the power supply 11 is an external power supply connected to the wire stripping system 10-1. The power supply 11 connects to a power source 35 (e.g., AC 110V outlet). The heating chamber 16 comprises an opening for a portion of an insulated wire to be placed inside. The wire stripping system 10-1 includes a start button 31 for the user to press to activate the wire stripping system 10-1. The top of the wire stripping system 10-1 includes two light emitting diodes (LED) to provide status information to the user. For example, the wait LED 32 is illuminated to tell the user not to insert an insulated wire or to keep an insulated wire already in the heating chamber 16 in place. The ready LED 33 is illuminated to tell the user the heating chamber 16 is ready for an insulated wire or to remove an insulated wire already in the heating chamber 16. An example operation of the wait LED 32 and the ready LED 33 is included in method 40 (FIG. 4) and method 60 (FIG. 6).

FIG. 3C-3D are schematic diagrams depicting the internal components of a wire stripping system 10-1 according to an embodiment of the invention, among others. The wire stripping system 10-1 comprises a heating system 20 (FIGS. 2A and 2B), a heating device 15, a heating chamber 16, a start button 31, a logic and timing circuit 34, and a power supply 11. The power supply 11 connects to the wire stripping system 10-1. In FIG. 3C, the power supply 11 is located external to the wire stripping system 10-1 and in FIG. 3D, the power supply 11 is located internal to the wire stripping system 10-1. The power supply 11 connects to a power source 35 (e.g., AC 110V outlet). In this example, the heating system 20 is depicted in FIGS. 2A-2B and comprises a heating chamber 16 and a heating device 15. The heating chamber 16 has an opening for an insulated wire to be inserted. The heating element 15 connects to the logic and timing circuit 34 where its temperature and time are regulated.

The logic and timing circuit 34 connects to the start button 31, to the power supply 11, and to the heating device 15. The logic and timing circuit 34 is configured to monitor and control the temperature inside the heating system 20. Additionally, the logic and timing circuit 34 is configured to regulate the time a portion of an insulated wire is in the heating chamber 16. The start button 31 activates the logic and timing circuit 34. The logic and timing circuit 34 provides power from the power supply 11 to the heating device (e.g., based on previously established and characterized routine). Finally, the logic and timing circuit 34 controls the wait LED 32 and ready LED 33 in FIG. 3A to notify the user when to start or remove the wire from the heating chamber 16.

FIG. 4 is a flowchart depicting a method 40 for operating a wire stripping system 10 according to an embodiment of the invention, among others. The method 40 comprises inserting a portion of an insulated wire into a heating chamber, as indicated in step 41. A start button is pressed to activate the wire stripping system, as indicated in step 42. A logic and a timing circuits determine the required temperature and time in the heating chamber, as indicated in step 43. A visual and/or an audio feedback indicates the wire heating has initiated, as indicated in step 44. For example, an LED may be turned off while the insulated wire is in the chamber. A visual and/or an audio feedback indicates the wire is ready to be removed from the heating chamber, as indicated in step 44. For example, an LED may be turned on to alert a user to remove the wire. The wire is removed from the heating chamber, as indicated in step 45.

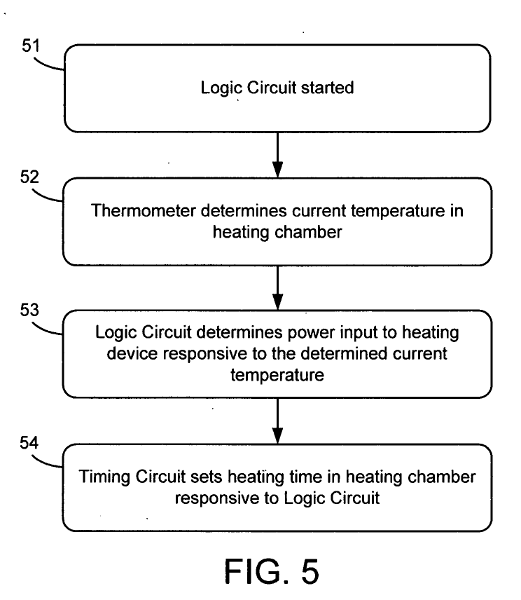

FIG. 5 is a flowchart depicting a method 50 for determining a required temperature and a time according to an embodiment of the invention, among others. The method 50 comprises starting the logic circuit (e.g., via a start button) (step 51); determining the current temperature in the heating chamber by a thermometer (step 52); determining the power input to the beating device responsive to the determined current temperature (step 53); and setting the heating time in the heating chamber responsive to the logic circuit (step 54).

FIG. 6 is a flowchart depicting a method 60 for operating a wire stripping system 10 according to an embodiment of the invention, among others. The method 60 comprises inserting a portion of an insulated wire into a heating chamber, as indicated in step 61. A start button is pressed to activate the wire stripping system, as indicated in step 62. A visual and/or an audio feedback indicates the wire heating has initiated, as indicated in step 63. For example, an LED may be turned off while the insulated wire is in the chamber. A visual and/or an audio feedback indicates the wire is ready to be removed from the heating chamber, as indicated in step 64. For example, an LED may be turned on to alert a user to remove the wire. The wire is removed from the heating chamber, as indicated in step 65. A visual and/or an audio feedback indicates the heating chamber is cooling, as indicated in step 66. For example, an LED may be turned on to alert the user the heating chamber is not ready to receive another wire. A visual and/or an audio feedback indicates the heating chamber is ready to receive another wire, as indicated in step 67.

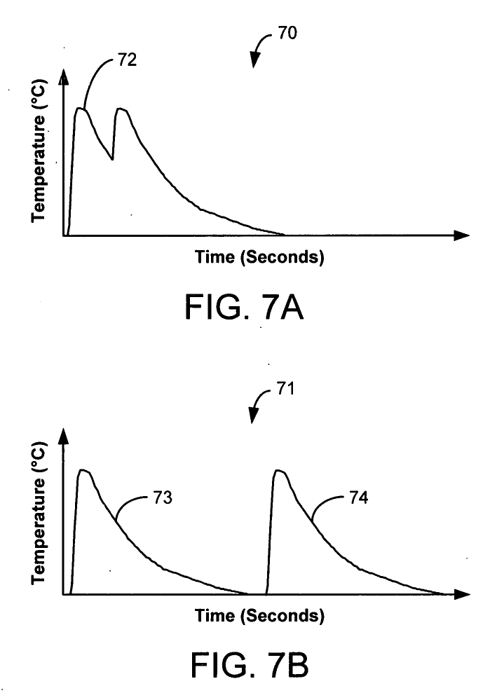

FIG. 7A is a graph 70 depicting temperature versus time in a heating chamber according to an embodiment of the invention, among others. The graph 70 depicts an operation similar to the method 40 (FIG. 4). Upon starting, a temperature 72 rises to a level responsive to the heating of the chamber. From this point, the temperature 72 cools over time. When the wire stripping system is started again, the system determines the current temperature and responds with heat to get to the require level as shown in method 40 (FIG. 4). This allows the wire stripping system to be heated only as needed depending on the current temperature. Method 40 (FIG. 4) allows the heating chamber to be reused without waiting for the temperature to stabilize at an ambient temperature.

FIG. 7B is a graph 71 depicting temperature versus time in a heating chamber according to an embodiment of the invention, among others. The graph 71 depicts an operation similar to the method 60 (FIG. 6). Upon starting, a temperature 73 rises to the required level, and the heating chamber cools over time. The system may be used again once the heating chamber has cooled to an ambient temperature. A temperature 74 rises again to the required level after starting the system again.

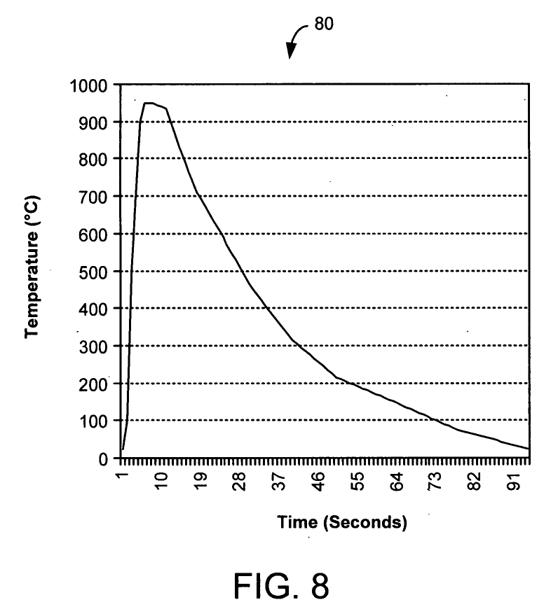

FIG. 8 is a graph 80 depicting an example temperature versus time in a heating chamber according to an embodiment of the invention, among others. In this example, the heating chamber is initially heated to approximately 950 deg. Celsius within approximately 5 seconds. The heating chamber remains at approximately 925 to 950 deg. Celsius for approximately 5 to 7 seconds while the wire is in the chamber, burning the insulation off the wire. The heating chamber cools from 925 deg. Celsius to the start temperature over approximately 80 seconds. In addition to the normal cooling, the heating chamber may include a cooling device (e.g., fan using factory air or other inert gases) to shorten the cooling time.

It should be emphasized that the above-described embodiments of the present invention are merely possible examples, among others, of the implementations, setting forth a clear understanding of the principles of the invention. Many variations and modifications may be made to the above-described embodiments of the invention without departing substantially from the principles of the invention. All such modifications and variations are intended to be included herein within the scope of the disclosure and present invention.

1. A wire stripping system comprises:
a heating chamber having at least one opening;
an electric heating device configured to heat said heating chamber; and
wherein heat generated by said heating device is configured to burn the insulation on a portion of a wire.

2. The wire stripping system of claim 1, further comprises a timing circuit configured to determine a time said portion of a wire is in said heating chamber.

3. The wire stripping system of claim 2, further comprises a logic circuit configured to determine an amount of power supplied to said electric heating device responsive to a temperature of said heating chamber.

4. The wire stripping system of claim 1, wherein said electric heating device is heated to a predetermined temperature.

5. The wire stripping system of claim 1, wherein:
said electric heating device comprises a wire configured to generate heat responsive to a current flowing through said wire; and
wherein said wire is wrapped around an exterior of said heating chamber.

6. The wire stripping system of claim 1, wherein said wire is a magnet wire having a diameter of less than or equal to about 0.03 inches.

7. The wire stripping system of claim 1, wherein said heating chamber has a cylindrical shape and an interior diameter of less than or equal to about 0.03 inches;

8. The wire stripping system of claim 1, further comprises a thermometer configured to measure an internal temperature of said heating chamber.

9. The wire stripping system of claim 1, further comprises a cooling device configured to cool said heating chamber.

10. The wire stripping system of claim 9, wherein said cooling device comprises a fan.

11. A method for using a wire stripping system, said method comprising:
inserting a portion of an insulated wire into a heating chamber of a wire stripping system;
removing said portion from said heating chamber responsive to feedback from said wire stripping system indicating that insulation has been burned on said portion; and
wherein said insulation is removed responsive to heat within said heating chamber.

12. The method of claim 11, further comprising removing charred residues of insulation from said portion by a light polish.

13. The method of claim 11, wherein said insulated wire is a magnet wire having a diameter of less than or equal to about 0.03 inches.

14. The method of claim 11, wherein said feedback is provided via at least one of a light and a sound.

15. A method for operating a wire stripping system, said method comprising:
receiving a portion of an insulated wire into a heating chamber of a wire stripping system;
heating said heating chamber to a predetermined temperature; and
providing a signal to a user instructing said user to remove said portion from said heating chamber after insulation has been burned on said portion.

16. The method of claim 15, further comprising determining a temperature of said heating chamber, wherein an amount of heat provided to said heating chamber is responsive to said temperature of said heating chamber.

17. The method of claim 15, further comprising removing charred residues of insulation from said portion by a light polish.

18. The method of claim 15, wherein said feedback is provided via at least one of a light and a sound.

19. The method of claim 15, further comprising providing a signal indicating said heating chamber is ready to receive a portion of another insulated wire.

20. The method of claim 15, wherein said wire stripping system comprises:
a heating chamber having at least one opening;
an electric heating device configured to heat said heating chamber; and
wherein heat generated by said heating device is configured to burn the insulation on a portion of a wire.
